(19) United States
(12) Patent Application Publication
(10) Pub. No.: US 2016/0156597 A1
(43) Pub. Date: Jun. 2, 2016

(54) Method, System and Device for Sending Configuration Information

(71) Applicant: ZTE Corporation, Shenzhen (CN)

(72) Inventors: Wei MENG, Shenzhen (CN); Zaifeng ZONG, Shenzhen (CN)

(21) Appl. No.: 14/898,537

(22) PCT Filed: Jun. 16, 2014
(86) PCT No.: PCT/CN2014/079982

§ 371 Date: Dec. 15, 2015

(30) Foreign Application Priority Data
Jul. 3, 2013 (CN) 201310277643.6

(51) Int. Cl. H04L 29/06; H04L 12/24

(52) U.S. Cl. CPC H04L 63/0428; H04L 41/0803; H04L 63/061

(57) ABSTRACT

The disclosure discloses a method, device and system for sending configuration information. The method includes: a central controller respectively configures a parameter set for each of multiple forwarding devices, wherein the parameter set is used for establishing Security Associations (SA) between each pair of forwarding devices in the multiple forwarding devices; the central controller negotiates with the each of the multiple forwarding devices and creates one or more security channels between the central controller and the each of the multiple forwarding devices; and the central controller sends the parameter set to the each of the multiple forwarding devices through the one or more security channels. According to the technical solutions provided by the disclosure, complexity in establishment of SAs among the multiple forwarding devices is lowered, and data transmission security is improved.

### TECHNICAL FIELD

The disclosure relates to the Internet field, and in particular to a method, system and device for sending configuration information.

### BACKGROUND

An Internet Protocol Security (IPSec) is a frame structure with an open standard, and as to the IPSec, development of secure communication on an Internet Protocol (IP) network may be ensured by encrypted security service.

The IPSec is not an independent protocol, and it provides a complete set of system structure applied to network data security on an IP layer, including: an Authentication Header (AH) protocol, an Encapsulating Security Payload (ESP) protocol, an Internet Key Exchange (IKE) protocol, some algorithms for network authentication and encryption, and the like, wherein the AH protocol and the ESP protocol may be used for providing security service, while the IKE protocol may be used for key exchange. Therefore, the IPSec provides two security mechanisms as follows: an authentication mechanism and an encryption mechanism.

First, the authentication mechanism enables a data receiver of IP communication to confirm real identity of a data sender and whether data is tampered in a transmission process or not; and

Second, the encryption mechanism performs encryption operation on data to ensure confidentiality of the data to prevent the data from being eavesdropped in a transmission process. The AH protocol in IPSec protocols defines an authentication application method, and provides data source authentication and ensures integrity; and the ESP protocol defines an encryption and optional authentication application method and ensures data reliability.

Security service provided for a data stream by IPSec may be implemented by a Security Association (SA), and may include: contents such as a protocol, an algorithm and a key, and specifically determines how to process an IP message. An SA is a one-way logic connection between two IPSec systems, and an input data stream and an output data stream are processed by an input SA and an output SA respectively. An SA is uniquely identified by a triple (a Security Parameter Index (SPI), a destination IP address and a security protocol number).

Network virtualization is developed on a basis of a cloud computing technology, and is based on a virtualization technology. In term of design of a router, the router consists of software control and a hardware data channel. The software control may include: management (for example: a Command Line Interface (CLI) and a Simple Network Management Protocol (SNMP)) and a routing protocol (for example: an Open Shortest Path First (OSPF) and a Border Gateway Protocol (BGP)). The hardware data channel may include: querying, exchanging and caching of each packet. If all forwarding devices in a network are considered as managed resources, a concept of a network Operating System (OS) may be abstracted with reference to a principle of an OS. The network OS abstracts a specific detail of bottom-layer forwarding device on one hand, and provides a unified management view and programming interface for an upper-layer application on the other hand. Therefore, a user may develop various application programs and define a logic network topology through software on a basis of the network OS to meet different requirements on network resources without concerning a physical topology structure of a bottom-layer network.

At present, the network virtualization include: an Openflow technology and Software Defined Network (SDN) architecture proposed by a Stanford University, an Interface to a Routing System (I2RS) architecture proposed by an Internet Engineering Task Force (IETF), and the like. Each of the abovementioned technologies has three forms as follows: a application controller, a forwarding device and a programmable interface. FIG. 1 is a schematic diagram showing a network virtualization framework according to the related art. As shown in FIG. 1, the three forms are respectively one or more central controllers, one or more virtual switches and one or more programmable interface in the SDN architecture and the Openflow; while the three forms are respectively one or more I2RS clients, one or more forwarding devices and one or more I2RS agents in the I2RS architecture.

In an existing IPSec technology, an SA may be established in one of the following manners: a manual configuration manner, a automatic negotiation manner. The manual configuration manner for the SA refers to manually setting preset parameters at two ends and establishing the SA after a parameter matching and negotiation of the two ends; and the automatic negotiation manner is generated and maintained by an IKE, and refers to performing matching and negotiation by two communication parties on a basis of own security policy database to finally establish the SA without user intervention.

When IPSec SAs are required to be established among multiple routers, whether the manual configuration manner or the automatic negotiation manner has two defects as follows:

Defect 1: when there are a huge number of routers, it is necessary to perform related SA configuration for each router, and operation is tedious and complex; and

Defect 2: if there are n routers, establishment of a negotiation channel between every two routers is required, and then (n−1)+(n−2)+(n−3)+ . . . +(n−(n−1)) negotiation signalling channels, i.e. n*(n−1)/2 channels, are occupied.

Moreover, no feasible methods are provided for a programmable interface between a controller and a forwarding device for establishment of an IPSec SA in an existing network virtualization technology, and consideration about security of the programmable interface in the existing network virtualization is inadequate, so that the existing network virtualization technology is inapplicable to establishment of the IPSec SA.

### SUMMARY

The embodiments of disclosure provide a method, system and device for sending configuration information, so as to at least solve the problem of tediousness, complexity and lower security of a manner of establishing SAs among multiple forwarding devices in the related art.

According to one aspect of the disclosure, a method for sending configuration information is provided.

A method for sending configuration information transmission according to the disclosure includes: a central controller configures a parameter set for each of multiple forwarding devices respectively, wherein the parameter set is used for establishing an SA between each pair of the forwarding devices in the multiple forwarding devices; the central controller negotiates with the each of the multiple forwarding devices and creates one or more security channels between the central controller and the each of the multiple forwarding devices; and the central controller sends the parameter set to the each of the multiple forwarding devices through the one or more security channels.

In an example embodiment, the central controller negotiates with the each of the multiple forwarding devices and creates one or more IPSec security channels between the central controller and the each of the multiple forwarding devices.

In an example embodiment, the central controller negotiates with the each of the multiple forwarding devices and creates the one or more security channels between the central controller and the each of the multiple forwarding devices includes: the central controller performs an IKE negotiation with the each of the multiple forwarding devices through a preset programmable interface; and when a consistent negotiation result is obtained, the central controller creates the one or more IPSec security channels between the central controller and the each of the multiple forwarding devices.

In an example embodiment, the central controller sends the parameter set to the each of the multiple forwarding devices through the one or more IPSec security channels includes: the central controller establishes secure connection with the each of the multiple forwarding devices through the one or more IPSec security channels; and the central controller sends the parameter set to the each of the multiple forwarding devices through a preset network protocol or in a preset management manner.

In an example embodiment, the preset network protocol or the preset management manner includes one of the followings: a telecommunication network protocol (TELNET); a Secure Shell Protocol (SSH); an SNMP; a network configuration protocol (NETCONF); a Customer Premise Device (CPE) wireless area network management protocol (TR069); a web open source system (WEBGUI)-based management manner; a File Transfer Protocol (FTP); a Trivial File Transfer Protocol (TFTP); a Secure File Transfer Protocol (SFTP); a system log; a Yet Another Next Generation (YANG) language mode; and a BGP.

In an example embodiment, after the central controller sends the parameter set to the each of the multiple forwarding devices through the one or more security channels, the method further includes: a first forwarding device in the multiple forwarding devices receives a data message to be forwarded to one or more second forwarding devices in the multiple forwarding devices; the first forwarding device acquires encapsulation mode information and key information from the parameter set, and performs, according to the encapsulation mode information and the key information, encryption and encapsulation processing on the data message to be forwarded; and the first forwarding device sends the encapsulated data message to the one or more second forwarding devices.

In an example embodiment, after the central controller sends the parameter set to the each of the multiple forwarding devices through the one or more security channels, the method further includes: the one or more second forwarding devices acquire decryption information from the parameter set, and decrypt the data message to be forwarded according to the decryption information; and the one or more second forwarding devices forward the decrypted data message.

In an example embodiment, after the central controller sends the parameter set to the each of the multiple forwarding devices through the one or more security channels, the method further includes: the central controller determines that a life cycle of the SA ends; and the central controller recalculates key information and recreates a parameter set to re-establish an SA.

In an example embodiment, the parameter sets include at least one of: a Virtual Private Network (VPN) type between the each pair of forwarding devices in the multiple forwarding devices; an SPI configured for the each of the multiple forwarding devices by the central controller; an IPSec tunnel source IP address configured for the each of the multiple forwarding devices by the central controller; an IPSec tunnel destination IP address configured for the each of the multiple forwarding devices by the central controller; a security protocol configured for the each of the multiple forwarding devices by the central controller; an encapsulation mode configured for the each of the multiple forwarding devices by the central controller; an encryption algorithm configured for the each of the multiple forwarding devices by the central controller; an encryption key calculated for the each of the multiple forwarding devices by the central controller; an integrity algorithm configured for the each of the multiple forwarding devices by the central controller; an integrity key calculated for the each of the multiple forwarding devices by the central controller; an anti-replay window size configured for the each of the multiple forwarding devices by the central controller; an SA life cycle type configured for the each of the multiple forwarding devices by the central controller; an ESP algorithm mode configured for the each of the multiple forwarding devices by the central controller; and an encryption mode configured for the each of the multiple forwarding devices by the central controller.

According to another aspect of the disclosure, a system for sending configuration information is provided.

A system for sending configuration information transmission according to the disclosure includes: a central controller, wherein the central controller includes: a configuration component, configured to configure a parameter set for each of multiple forwarding devices respectively, wherein the parameter set is used for establishing an SA between each pair of the forwarding devices in the multiple forwarding devices; a creation component, configured to negotiate with the each of the multiple forwarding devices and create one or more security channels between the central controller and the each of the multiple forwarding devices; and a sending component, configured to send the parameter sets to the each of the multiple forwarding devices through the one or more security channels.

In an example embodiment, the creation component is configured to respectively negotiate with the each of the multiple forwarding devices and create one or more IPSec security channels between the central controller and the each of the multiple forwarding devices.

In an example embodiment, the creation component includes: a negotiation element, configured to perform an IKE negotiation with the each of the multiple forwarding devices through a preset programmable interface; and a creation element, configured to, when a output of the negotiation element is YES, create the one or more IPSec security channels between the central controller and the each of the multiple forwarding devices.

In an example embodiment, the sending component includes: a connection element, configured to establish secure connection with the each of the multiple forwarding devices through the one or more IPSec security channels; and a sending element, configured to send the parameter set to the each of the multiple forwarding devices through a preset network protocol or in a preset management manner.

In an example embodiment, the preset network protocol or the preset management manner includes one of: a TELNET; an SSH; an SNMP; a NETCONF; a CPE TR069; a WEBGUI-based management manner; an FTP; a TFTP; an SFTP; a system log; a YANG language mode; and a BGP.

In an example embodiment, the system further includes: a first forwarding device in the multiple forwarding devices, wherein the first forwarding device includes: a receiving component, configured to receive a data message to be forwarded to one or more second forwarding devices in the multiple forwarding devices; an encapsulation component, configured to acquire encapsulation mode information and key information from the parameter set, and perform, according to the encapsulation mode information and the key information, encryption and encapsulation processing on the data message to be forwarded; and a sending component, configured to send the encapsulated data message to the one or more second forwarding devices.

In an example embodiment, the system further includes: the one or more second forwarding devices, wherein each of the one or more second forwarding devices includes: a decryption component, configured to acquire decryption information from the parameter set, and decrypt the data message to be forwarded according to the decryption information; and a forwarding component, configured to forward the decrypted data message.

In an example embodiment, the central controller further includes: a determination component, configured to determine that a life cycle of the SA ends; and a creation component, configured to recalculate key information and recreate a parameter set to re-establish an SA.

In an example embodiment, the parameter sets include at least one of: a VPN type between the each pair of the forwarding devices in the multiple forwarding devices; an SPI configured for the each of the multiple forwarding devices by the central controller; an IPSec tunnel source IP address configured for the each of the multiple forwarding devices by the central controller; an IPSec tunnel destination IP address configured for the each of the multiple forwarding devices by the central controller; a security protocol configured for the each of the multiple forwarding devices by the central controller; an encapsulation mode configured for the each of the multiple forwarding devices by the central controller; an encryption algorithm configured for the each of the multiple forwarding devices by the central controller; an encryption key calculated for the each of the multiple forwarding devices by the central controller; an integrity algorithm configured for the each of the multiple forwarding devices by the central controller; an integrity key calculated for the each of the multiple forwarding devices by the central controller; an anti-replay window size configured for the each of the multiple forwarding devices by the central controller; an SA life cycle type configured for the each of the multiple forwarding devices by the central controller; an ESP algorithm mode configured for the each of the multiple forwarding devices by the central controller; and an encryption mode configured for the each of the multiple forwarding devices by the central controller.

According to the other aspect of the disclosure, a device for sending configuration information is provided.

A device for sending configuration information according to the disclosure includes: a configuration component, configured to configure a parameter set for each of multiple forwarding devices respectively, wherein the parameter set is used for establishing an SA between each pair of the forwarding devices in the multiple forwarding devices; a creation component, configured to negotiate with the each of the multiple forwarding devices and create one or more security channels between the central controller and een the each of the multiple forwarding devices; and a sending component, configured to send the parameter set to the each of the multiple forwarding devices through the one or more security channels.

According to the disclosure, the central controller is adopted to configure the parameter set for the each of the multiple forwarding devices, wherein the parameter set is used for establishing the SA between each pair of the forwarding devices in the multiple forwarding devices; the central controller negotiates with the each of the multiple forwarding devices and create one or more security channels between the central controller and the each of the multiple forwarding devices; and the central controller sends the parameter set to the each of the multiple forwarding devices through the one or more security channels. With adoption of the central controller, original establishment of the SAs among the multiple forwarding devices is replaced by configuring the parameter set for the each of the multiple forwarding devices by the central controller and negotiating with the each of the multiple forwarding devices and create one or more security channels between the central controller and the each of the multiple forwarding devices, so that the problem in the related art of tediousness, complexity and lower security of the manner of establishing the SAs among the multiple forwarding devices is solved, complexity in the establishment of the SAs among the multiple forwarding devices is further lowered, and data transmission security is further improved.

### BRIEF DESCRIPTION OF THE DRAWINGS

Drawings, provided for further understanding of the disclosure and forming a part of the specification, are used to explain the disclosure together with embodiments of the disclosure rather than to limit the disclosure, wherein:

FIG. 1 is a schematic diagram of a network virtualization framework according to the related art;

FIG. 2 is a flowchart of a method for sending configuration information according to an embodiment of the disclosure;

FIG. 3 is a schematic diagram of a network topology structure for creating IPSec SAs according to an example embodiment of the disclosure;

FIG. 4 is a structural block diagram of a system for sending configuration information according to an embodiment of the disclosure;

FIG. 5 is a structural block diagram of a system for sending configuration information according to an example embodiment of the disclosure; and

FIG. 6 is a structural block diagram of a device for sending configuration information according to an embodiment of the disclosure.

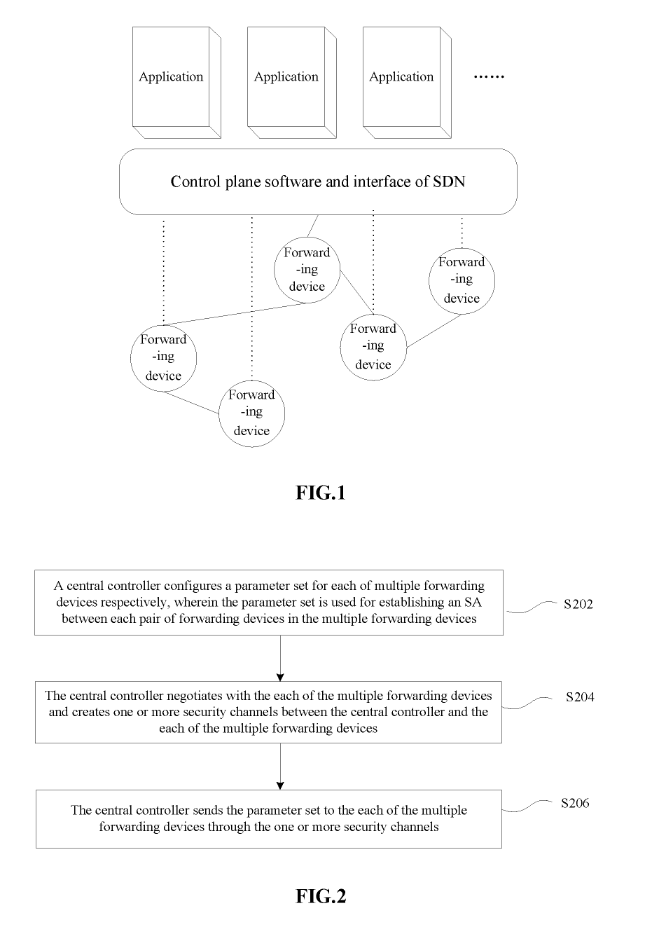

### DETAILED DESCRIPTION OF THE EMBODIMENTS

The disclosure is described below with reference to the accompanying drawings and embodiments in detail. Note that, the embodiments of the disclosure and the features of the embodiments may be combined with each other if there is no conflict.

FIG. 2 is a flowchart of a method for sending configuration information according to an embodiment of the disclosure. As shown in FIG. 2, the method may include the following processing steps:

Step S202: a central controller configures a parameter set for each of multiple forwarding devices respectively, wherein the parameter set is used for establishing an SA between each pair of the forwarding devices in the multiple forwarding devices;

Step 204: the central controller negotiates with the each of the multiple forwarding devices and creates one or more security channels between the central controller and the each of the multiple forwarding devices; and

Step 206: the central controller sends the parameter set to the each of the multiple forwarding devices through the one or more security channels.

A manner of establishing SAs among multiple forwarding devices in the related art is tedious, complex and lower in security. By the method shown in FIG. 2, the central controller configures the parameter set for each of the multiple forwarding devices, wherein the parameter set is used for establishing the SA between each pair of the forwarding devices in the multiple forwarding devices; the central controller negotiates with the each of the multiple forwarding devices and creates one or more security channels between the central controller and the each of the multiple forwarding devices; and the central controller sends the parameter set to each of the multiple forwarding devices through the one or more security channels. With adoption of the central controller, original establishment of the SAs among the multiple forwarding devices is replaced by configuring the parameter set for each of the multiple forwarding devices by the central controller and negotiating and creating the security channels with each of the multiple forwarding devices to establish the SAs among the multiple forwarding devices, so that the problem in the related art of tediousness, complexity and lower security of the manner of establishing the SAs among the multiple forwarding devices in the related are is solved, complexity in the establishment of the SAs among the multiple forwarding devices is further lowered, and data transmission security is further improved.

In an example implementation process, the central controller negotiates with the each of the multiple forwarding devices and creates one or more IPSec security channels between the central controller and the each of the multiple forwarding devices.

In an example embodiment, in Step S204, that the central controller negotiates with the each of the multiple forwarding devices and creates one or more security channels between the central controller and the each of the multiple forwarding devices may include the following operation:

Step S1: the central controller performs an IKE negotiation with each of the multiple forwarding devices through a preset programmable interface; and

Step S2: when a consistent negotiation result is obtained, the central controller creates the one or more IPSec security channels between the central controller and the each of the multiple forwarding devices.

In the example embodiment, two forwarding devices (i.e. forwarding device 1 and forwarding device 2) are taken as an example, and the forwarding device 1 establishes an IPSec security channel with the central controller by static configuration, and performs IPSec option negotiation, authenticates each end of communication and manages a session key of an IPSec tunnel through an IKE protocol. The forwarding device 2 establishes an IPSec security channel with the central controller by static configuration, and performs IPSec option negotiation, authenticates each end of communication and manages a session key of an IPSec tunnel through the IKE protocol. After the above-mentioned processing is finished, links established between each forwarding device and the central controller through programmable interfaces are safe and reliable.

In an example embodiment, in Step S206, the central controller sends the parameter set to the each of the multiple forwarding devices through the one or more IPSec security channels may include the following steps:

Step S3: the central controller performs secure connection with the each of the multiple forwarding devices through the one or more IPSec security channels; and

Step S4: the central controller sends the parameter set to the each of the multiple forwarding devices through a preset network protocol or in a preset management manner.

In the example embodiment, the central controller sends parameters required by each of the two forwarding devices to the forwarding device 1 and the forwarding device 2 through the preset network protocol or in the preset management manner. Messages which are transmitted by the central controller through the preset network protocol and formed by the parameters are subjected to IPSec encryption processing of the central controller to be converted into a ciphertext format for transmission in a network until the messages reach the two forwarding devices. The forwarding device 1 and the forwarding device 2 perform decryption processing on the configuration messages after receiving the configuration messages, and then write the configuration messages into SA table entries of own IPSec components. The forwarding devicel and the forwarding device 2 implement establishment of SAs. An IKE signalling channel between the two forwarding devices is replaced with one IKE signalling channel between each of the two forwarding devices and the central controller, and if a number of the multiple forwarding devices is N, a number of signalling channels is also N, so that the problem that the number of IKE signalling channels is a square of N in the related art is solved. At this moment, security encryption processing may be adopted for data transmission between the forwarding device 1 and the forwarding device 2.

In an example implementation process, the preset network protocol or the preset management manner may include, but not limited to, one of the followings: a TELNET; an SSH; an SNMP; a NETCONF; a CPE TR069; a WEBGUI-based management manner; an FTP; a TFTP; a SFTP; a system log; a YANG language mode; and a BGP.

In an example embodiment, after the central controller sends the parameter set to each of the multiple forwarding devices through the one or more security channels in Step S206, the method may further include the following operation:

Step S5: a first forwarding device in the multiple forwarding devices receives a data message to be forwarded to one or more second forwarding devices in the multiple forwarding devices;

Step S6: the first forwarding device acquires encapsulation mode information and key information from the parameter set, and performs encryption encapsulation processing on the data message to be forwarded according to the encapsulation mode information and the key information; and

Step S7: the first forwarding device sends the encapsulated data message to the one or more second forwarding devices.

In the example embodiment, when a data packet to be forwarded is required to be sent from the forwarding device 1 to the forwarding device 2, the forwarding device 1 may search for a corresponding SA table entry and perform encryption encapsulation processing on a message through an ESP tunnel mode and key information (including: an encryption key and an integrity key) according to a content of the table entry at first, and then send the message to the forwarding device 2.

In an example embodiment, after the central controller sends the parameter set to the each of the multiple forwarding devices through the one or more security channels in Step S206, the method may further include the following steps:

Step S8: the one or more second forwarding devices acquire decryption information from the parameter set, and decrypt the data message to be forwarded by adopting the decryption information; and

Step S9: the one or more second forwarding devices forward the decrypted data message.

In the example embodiment, when a data packet to be forwarded reaches the forwarding device 2, the forwarding device 2 may search for a corresponding SA table entry and perform decryption processing on a message according to a content of the table entry, and then forward the decrypted message.

In an example embodiment, after the central controller sends the parameter set to the each of the multiple forwarding devices through the one or more security channels in Step S206, the method may further include the following steps:

Step S10: the central controller determines that a life cycle of the SA end; and

Step S11: the central controller recalculates key information and recreates a parameter set to re-establish an SA.

In the example embodiment, when the SAs expire, the central controller needs to recalculate key information (including an encryption key and an integrity key) and recreate an SA between each pair of the forwarding devices in the multiple forwarding devices.

In the example implementation process, the parameter set may include, but not limited to, at least one of the followings:

a VPN type between the each pair of the forwarding devices in the multiple forwarding devices;

an SPI configured for the each of the multiple forwarding devices by the central controller;

an IPSec tunnel source IP address configured for the each of the multiple forwarding devices by the central controller;

an IPSec tunnel destination IP address configured for the each of the multiple forwarding devices by the central controller;

a security protocol configured for the each of the multiple forwarding devices by the central controller;

an encapsulation mode configured for the each of the multiple forwarding devices by the central controller;

an encryption algorithm configured for the each of the multiple forwarding devices by the central controller;

an encryption key calculated for the each of the multiple forwarding devices by the central controller;

an integrity algorithm configured for the each of the multiple forwarding devices by the central controller;

an integrity key calculated for the each of the multiple forwarding devices by the central controller;

an anti-replay window size configured for the each of the multiple forwarding devices by the central controller;

an SA life cycle type configured for the each of the multiple forwarding devices by the central controller;

an ESP algorithm mode configured for the each of the multiple forwarding devices by the central controller;

and an encryption mode configured for the each of the multiple forwarding devices by the central controller.

It needs to be noted that the encryption key and the integrity key of each parameter in the parameter set may be calculated by the central controller, and the other parameters may be configured for the each of the multiple forwarding devices by the central controller.

In the example embodiment, the central controller may configure the following parameters to the each of the multiple forwarding devices:

the VPN type between the each pair of the forwarding devices in the multiple forwarding devices, for example: IPSec and Layer-2 Virtual Private Network (L2VPN);

related configurations made to the multiple forwarding devices by the central controller are as follows:

(1) an SPI;

(2) an IPSec tunnel source IP address;

(3) an IPSec tunnel destination IP address;

(4) a security protocol, for example: an AH or an ESP;

(5) an encapsulation mode, for example: a transmission mode or a tunnel mode;

(6) an encryption algorithm;

(7) an encryption key;

(8) an integrity algorithm;

(9) an integrity key;

(10) an anti-replay window size;

(11) an SA life cycle type, for example: time, a byte and a combination of byte and time;

(12) an ESP algorithm mode, for example: an encryption algorithm or a compression algorithm; and

(13) an encryption mode, for example: a Electronic Code Book (ECB) mode, a Cipher Block Chaining (CBC) mode, a Cipher FeedBack (CFB) mode, a Output FeedBack (OFB) mode, a Counter (CTR) mode and a variant F8 mode of a OFB mode.

In addition, in the technical solution provided by the disclosure, other optional parameters may further be set, and may be specifically set according to a practical condition, which will not be described in detail here.

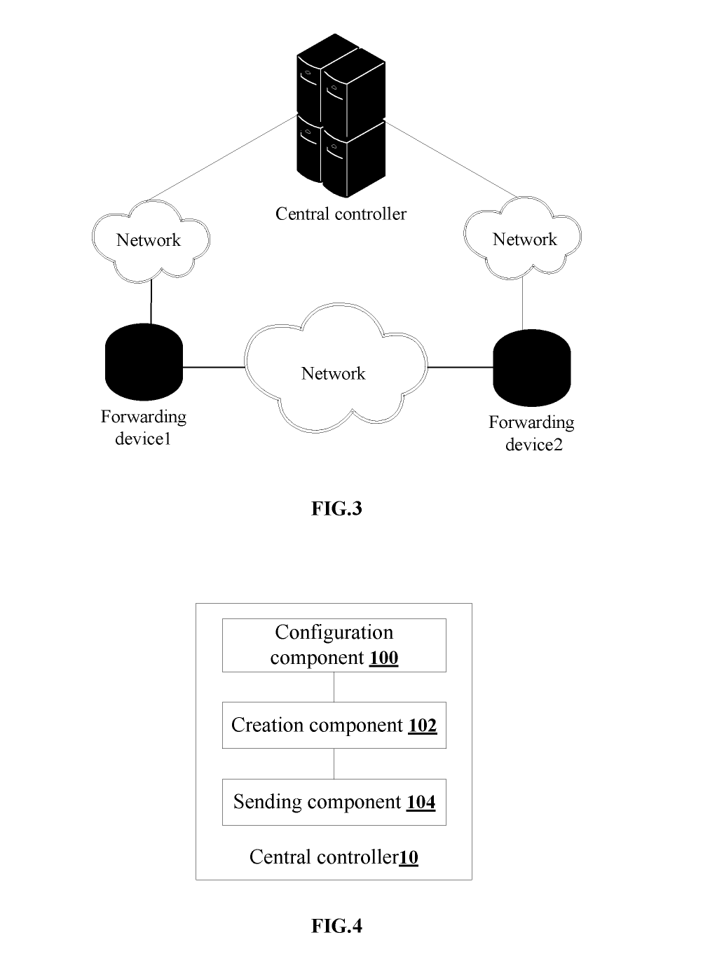

The example implementation process is further described below with reference to an example implementation mode shown in FIG. 3 in detail.

FIG. 3 is a schematic diagram of a network topology structure for creating with IPSec SAs according to an example embodiment of the disclosure. As shown in FIG. 3, a forwarding device 1 and a forwarding device 2 are required to establish an SA and establish a security transmission channel in an IPSec manner. The forwarding device 1 and the forwarding device 2 are respectively connected with the central controller through a programmable interface, and create an IPSec SA through parameters sent by the central controller.

Step 1: the central controller performs parameter configuration, which may specifically include:

(1) comprehensive configuration:

configuring a VPN type between the forwarding device 1 and the forwarding device 2 to be an IPSec; and

configuring an SNMP client.

(2) configuration for the forwarding device 1 and he forwarding device 2:

configuring an SPI value of the forwarding device 1 to be 1024 and configuring an SPI value of the forwarding device 2 to be 2048;

configuring an IPSec tunnel source IP address of the forwarding device 1 to be 202.1.1.1 and configuring an IPSec tunnel destination IP address of the forwarding device 1 to be 202.1.2.1;

configuring an IPSec tunnel source IP address of the forwarding device 2 to be 202.1.2.1 and configuring an IPSec tunnel destination IP address of the forwarding device 1 to be 202.1.1.1;

configuring a security protocol between the forwarding device 1 and the forwarding device 2 to be an ESP;

configuring an IPSec encapsulation mode between the forwarding device 1 and the forwarding device 2 to be a tunnel model;

configuring an encryption algorithm between the forwarding device 1 and the forwarding device 2 to be a Data Encryption Standard (DEs);

configuring an encryption key between the forwarding device 1 and the forwarding device 2 to be X (56-bit binary number);

configuring anti-replay window sizes of both the forwarding device 1 and the forwarding device 2 to be 64;

configuring an SA life cycle type of the forwarding device 1 and the forwarding device 2 to be 2,400 seconds;

configuring an ESP algorithm mode of the forwarding device 1 and the forwarding device 2 to be an encryption algorithm; and

configuring an encryption mode of the forwarding device 1 and the forwarding device 2 to be an ECB.

(3) parameter configuration on the forwarding device 1:

configuring an interface between the forwarding device 1 and the central controller to be an FEI_1/1, and performing an IPSec VPN and IKE configuration; and opening an SNMP function of FEI_1/1.

(4) parameter configuration on the forwarding device 2:

configuring an interface between forwarding device 2 and the central controller to be an FEI_1/2, and performing an IPSec VPN and IKE configuration; and opening an SNMP function of FEI_1/2.

Step 2: the central controller negotiates a key with interface the FEI_1/1 of the forwarding device 1 through the IKE, and creates an IPSec security channel.

Step 3: the central controller negotiates a key with interface the FEI_1/2 of the forwarding device 2 through the IKE, and creates an IPSec security channel.

Step 4: the central controller is securely connected to the forwarding device 1 through the IPSec security channel created in Step 2 by virtue of an Management Information Base (MIB) software.

Step 5: the central controller securely writes configuration information about the forwarding device 1 on the central controller into an IPSec SA table of the forwarding device 1 through the IPSec security channel created in Step 2 by virtue of the MIB software.

Step 6: the central controller is securely connected to the forwarding device 2 through the IPSec security channel created in Step 3 by virtue of the MIB software.

Step 7: the central controller securely writes configuration information about the forwarding device 2 on the central controller into an IPSec SA table of the forwarding device 2 through the IPSec security channel created in Step 3 by virtue of the MIB software.

Step 8: when a data packet to be forwarded is required to be sent from the forwarding device 1 to the forwarding device 2, the forwarding device 1 may search for a corresponding SA table entry and perform encryption encapsulation on a message according to a content of the table entry through an ESP tunnel mode at first, and then send the message to the forwarding device 2.

Step 9: when a data packet to be forwarded reaches the forwarding device 2, the forwarding device 2 may search for a corresponding SA table entry and perform decryption processing on a message according to a content of the table entry, and then forward the message.

Step 10: when a life cycle of the SA ends after 2,400 seconds, the central controller may recalculate a key and transmit a new SA to the forwarding device 1 and the forwarding device 2.

To sum up, the forwarding device 1 and the forwarding device 2 create the IPSec SA and manage the IPSec SA through the central controller.

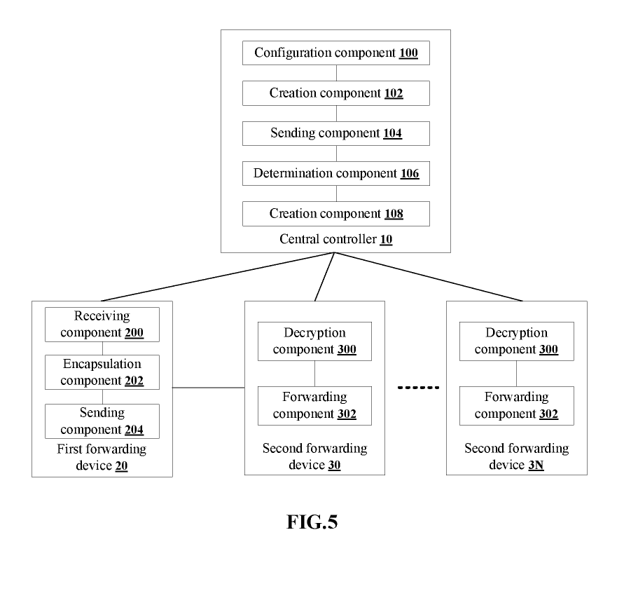

FIG. 4 is a structural block diagram of a system for sending configuration information according to an embodiment of the disclosure. As shown in FIG. 4, the system for sending configuration information may include: a central controller 10, wherein the central controller 10 may include: a configuration component 100, configured to respectively configure a configure parameter set for each of the multiple forwarding devices, wherein the parameter set is used for establishing an SA between each pair of the forwarding devices in the forwarding devices; a creation component 102, configured to negotiate the each of the multiple forwarding devices and create one or more security channels between the central controller and the each of the multiple forwarding devices; and a transmission component 104, configured to send the parameter set to the each of the multiple forwarding devices through the security channels.

By the system shown in FIG. 4, the problem of tediousness, complexity and lower security of a manner of establishing SAs among the multiple forwarding devices in the related art is solved, complexity in the establishment of the SAs among the multiple forwarding devices is further lowered, and data transmission security is further improved.

In an example embodiment, the creation component 102 is configured to respectively negotiate with the each of the multiple forwarding devices and create one or more IPSec security channels between the central controller and the each of the multiple forwarding devices.

In an example embodiment, the creation component 102 may include: a negotiation element (not shown in FIG. 4), configured to perform an IKE negotiation with the each of the multiple forwarding devices through a preset programmable interface; and a creation element (not shown in FIG. 4), configured to, when a output of the negotiation element is YES, create the one or more IPSec security channels between the central controller and the each of the multiple forwarding devices.

In an example embodiment, the sending component 104 may include: a connection element (not shown in FIG. 4), configured to perform secure connection with the each of the multiple forwarding devices through the one or more IPSec security channels; and a sending element (not shown in FIG. 4), configured to send the parameter set to the each of the multiple forwarding devices through a preset network protocol or in a preset management manner.

In an example implementation process, the preset network protocol or the preset management manner may include, but not limited to, one of: a TELNET; an SSH; an SNMP; a NETCONF; a CPE TR069; a WEBGUI-based management manner; an FTP; a TFTP; an SFTP; a system log; a YANG language mode; and a BGP.

In an example embodiment, as shown in FIG. 5, the system may further include: a first forwarding device 20 of the multiple forwarding devices, wherein the first forwarding device 20 may include: a receiving component 200, configured to receive a data message to be forwarded to one or more second forwarding devices in the multiple forwarding devices; an encapsulation component 202, configured to acquire encapsulation mode information and key information from the parameter set, and perform encryption encapsulation processing on the data message to be forwarded according to the encapsulation mode information and the key information; and a sending component 204, configured to send the encapsulated data message to the one or more second forwarding devices.

In an example embodiment, as shown in FIG. 5, the system may further include: the one or more second forwarding devices 30, wherein each of the one or more second forwarding devices 30 may include: a decryption component 300, configured to acquire decryption information from the parameter set, and decrypt the data message to be forwarded by adopting the decryption information; and a forwarding component 302, configured to forward the decrypted data message.

In an example embodiment, as shown in FIG. 5, the central controller may further include: a determination component 106, configured to determine that a life cycles of the SA ends; and a creation component 108, configured to recalculate key information and recreate a parameter set to re-establish an SA.

In the example implementation process, the parameter set may include, but not limited to, at least one of:

a VPN type between the each pair of the forwarding devices in forwarding devices;

an SPI configured for the each of the multiple forwarding devices by the central controller;

an IPSec tunnel source IP address configured for the each of the multiple forwarding devices by the central controller;

an IPSec tunnel destination IP address configured for the each of the multiple forwarding devices by the central controller;

a security protocol configured for the each of the multiple forwarding devices by the central controller;

an encapsulation mode configured for the each of the multiple forwarding devices by the central controller;

an encryption algorithm configured for the each of the multiple forwarding devices by the central controller;

an encryption key calculated for the each of the multiple forwarding devices by the central controller;

an integrity algorithm configured for the each of the multiple forwarding devices by the central controller;

an integrity key calculated for the each of the multiple forwarding devices by the central controller;

an anti-replay window size configured for the each of the multiple forwarding devices by the central controller;

an SA life cycle type configured for the each of the multiple forwarding devices by the central controller;

an ESP algorithm mode configured for the each of the multiple forwarding devices by the central controller; and

an encryption mode configured for the each of the multiple forwarding devices by the central controller.

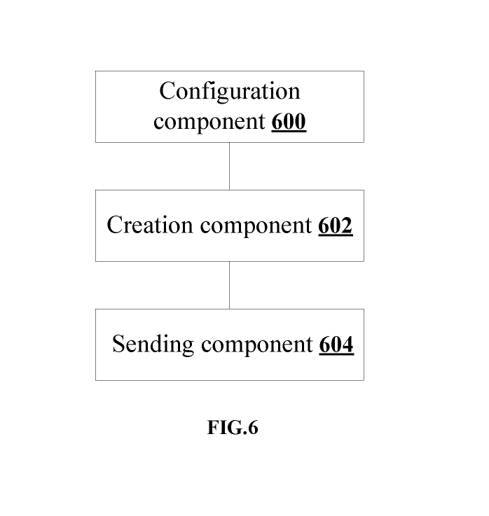

FIG. 6 is a structural block diagram of a device for sending configuration information according to an embodiment of the disclosure. As shown in FIG. 6, the device for sending configuration information may include: a configuration component 600, configured to respectively configure a parameter set for each of multiple forwarding devices, wherein the parameter set is used for establishing an SA between each pair of the forwarding devices in the multiple forwarding devices; a creation component 602, configured to negotiate with the each of the multiple forwarding devices and create one or more security channels between the central controller and the each of the multiple forwarding devices; and a sending component 604, configured to send the parameter set to the each of the multiple forwarding devices through the one or more security channels.

From the above, it can be seen that the embodiment achieves the following technical effects (it is important to be noted that these effects are effects achievable for some example embodiments): the disclosure provides a technical solution for creating IPSec SAs, particularly a technical solution for creating IPSec SAs on the basis of a network virtualization architecture. Therefore, the problem of tediousness and complexity of configuration work under the condition that there are a huge number of routers in the related art is solved, an interaction process of many IKE signalling messages between the multiple forwarding devices is simplified, and an occupied bandwidth is reduced; and in addition, problem about security of high-level parameter transmission between the multiple forwarding devices and the central controller may also be solved, and meanwhile, it is agreed that the central controller performs IPSec parameter configuration of the multiple forwarding devices in a network virtualization framework.

Obviously, those skilled in the art should know that each of the mentioned components or steps of the disclosure may be realized by universal computing devices; the modules or steps may be focused on single computing device, or distributed on the network formed by multiple computing devices; selectively, they may be realized by the program codes which may be executed by the computing device; thereby, the modules or steps may be stored in the storage device and executed by the computing device; and under some circumstances, the shown or described steps may be executed in different orders, or may be independently manufactured as each integrated circuit module, or multiple modules or steps thereof may be manufactured to be single integrated circuit module, thus to be realized. In this way, the disclosure is not restricted to any particular hardware and software combination.

The descriptions above are only the preferable embodiment of the disclosure, which are not used to restrict the disclosure, for those skilled in the art, the disclosure may have various changes and variations. Any amendments, equivalent substitutions, improvements, etc. within the principle of the disclosure are all included in the scope of the protection of the disclosure.

### INDUSTRIAL APPLICABILITY

From the above, the method, system and device for sending configuration information provided by the embodiments of the disclosure have the following beneficial effects: the problem of tediousness and complexity of configuration work under the condition that there are a huge number of routers in the related art is solved, an interaction process of many IKE signalling messages among multiple forwarding devices is simplified, and an occupied bandwidth is reduced; and in addition, problem about security of high-level parameter transmission between each of the multiple forwarding devices and a central controller may also be solved, and meanwhile, it is agreed that the central controller performs IPSec parameter configuration of the multiple forwarding devices in a network virtualization framework.

1. A method for sending configuration information, comprising:
respectively configuring, by a central controller, a parameter set for each of multiple forwarding devices, wherein the parameter set is used for establishing an Security Association, SA, between each pair of forwarding devices in the multiple forwarding devices;
negotiating, by the central controller, with the each of the multiple forwarding devices and creating, by the central controller, one or more security channels between the central controller and the each of the multiple forwarding devices; and
sending, by the central controller, the parameter set to the each of the multiple forwarding devices through the one or more security channels.

2. The method as claimed in claim 1, wherein the central controller negotiates with the each of the multiple forwarding devices and creates one or more Internet Protocol Security, IPSec, security channels between the central controller and the each of the multiple forwarding devices.

3. The method as claimed in claim 2, wherein negotiating, by the central controller, with the each of the multiple forwarding devices and creating, by the central controller, one or more security channels between the central controller and the each of the multiple forwarding devices comprises:
performing, by the central controller, an Internet Key Exchange, IKE, negotiation with the each of the multiple forwarding devices through a preset programmable interface; and
when a consistent negotiation result is obtained, creating, by the central controller, the one or more IPSec security channels between the central controller and the each of the multiple forwarding devices.

4. The method as claimed in claim 2, wherein sending, by the central controller, the parameter set to the each of the multiple forwarding devices through the one or more IPSec security channels comprises:
establishing, by the central controller, secure connection with the each of the multiple forwarding devices through the one or more IPSec security channels; and
sending, by the central controller, the parameter set to the each of the multiple forwarding devices through a preset network protocol or in a preset management manner.

5. The method as claimed in claim 4, wherein the preset network protocol or the preset management manner comprises one of the followings:
a telecommunication network protocol, TELNET;
a Secure Shell Protocol, SSH;
a Simple Network Management Protocol, SNMP;
a network configuration protocol, NETCONF;
a Customer Premise Equipment, CPE, wireless area network management protocol, TR069;
a web open source system, WEBGUI, -based management manner;
a File Transfer Protocol, FTP;
a Trivial File Transfer Protocol, TFTP;
a Secure File Transfer Protocol, SFTP;
a system log;
a Yet Another Next Generation, YANG language mode; and
a Border Gateway Protocol, BGP.

6. The method as claimed in claim 1, after sending, by the central controller, the parameter set to the each of the multiple forwarding devices through the one or more security channels, the method further comprises:
receiving, by a first forwarding device in the multiple forwarding devices, a data message to be forwarded to one or more second forwarding devices in the multiple forwarding devices;
acquiring, by the first forwarding device, encapsulation mode information and key information from the parameter set, and performing, by the first forwarding device according to the encapsulation mode information and the key information, encryption and encapsulation processing on the data message to be forwarded; and
sending, by the first forwarding device, the encapsulated data message to the one or more second forwarding devices.

7. The method as claimed in claim 6, after sending, by the central controller, the parameter set to the each of the multiple forwarding devices through the one or more security channels, the method further comprises:
acquiring, by the one or more second forwarding devices, decryption information from the parameter set, and decrypting, by the one or more second forwarding devices according to the decryption information, the data message to be forwarded; and
forwarding, by the one or more second forwarding devices, the decrypted data message.

8. The method as claimed in claim 1, after sending, by the central controller, the parameter set to the each of the multiple forwarding devices through the one or more security channels, the method further comprises:
determining, by the central controller, that a life cycle of the SA ends; and
recalculating, by the central controller, key information, and recreating, by the central controller, a parameter set to re-establish an SA.

9. The method as claimed in claim 1, wherein the parameter set comprises at least one of:
a Virtual Private Network, VPN, type between the each pair of the forwarding devices in the multiple forwarding devices;
a Security Parameter Index, SPI, configured for the each of the multiple forwarding devices by the central controller;
an IPSec tunnel source Internet Protocol, IP, address configured for the each of the multiple forwarding devices by the central controller;
an IPSec tunnel destination IP address configured for the each of the multiple forwarding devices by the central controller;
a security protocol configured for the each of the multiple forwarding devices by the central controller;
an encapsulation mode configured for the each of the multiple forwarding devices by the central controller;
an encryption algorithm configured for the each of the multiple forwarding devices by the central controller;
an encryption key calculated for the each of the multiple forwarding devices by the central controller;
an integrity algorithm configured for the each of the multiple forwarding devices by the central controller;
an integrity key calculated for the each of the multiple forwarding devices by the central controller;
an anti-replay window size configured for the each of the multiple forwarding devices by the central controller;
an SA life cycle type configured for the each of the multiple forwarding devices by the central controller;
an Encapsulating Security Payload, ESP, algorithm mode configured for the each of the multiple forwarding devices by the central controller; and
an encryption mode configured for the each of the multiple forwarding devices by the central controller.

10. A system for sending configuration information, comprising: a central controller, wherein
the central controller comprises:
a configuration component, configured to respectively configure a parameter set for each of multiple forwarding devices, wherein the parameter set is used for establishing an Security Association, SA, between each pair of forwarding devices in the multiple forwarding devices;
a creation component, configured to negotiate with the each of the multiple forwarding devices and create one or more security channels between the central controller and the each of the multiple forwarding devices; and
a sending component, configured to send the parameter set to the each of the multiple forwarding devices through the one or more security channels.

11. The system as claimed in claim 10, wherein the creation component is configured to respectively negotiate with the each of the multiple forwarding devices and create one or more Internet Protocol Security, IPSec, security channels between the central controller and the each of the multiple forwarding devices.

12. The system as claimed in claim 11, wherein the creation component comprises:
a negotiation element, configured to perform an Internet Key Exchange, IKE, negotiation with the each of the multiple forwarding devices through a preset programmable interface; and
a creation element, configured to, when a output of the negotiation element is YES, create the one or more IPSec security channels between the central controller and the each of the multiple forwarding devices.

13. The system as claimed in claim 11, wherein the sending component comprises:
a connection element, configured to establish secure connection with the each of the multiple forwarding devices through the one or more IPSec security channels; and
a sending element, configured to send the parameter set to the each of the multiple forwarding devices through a preset network protocol or in a preset management manner.

14. The system as claimed in claim 13, wherein the preset network protocol or the preset management manner comprises one of the followings:
a telecommunication network protocol, TELNET;
a Secure Shell Protocol, SSH;
a Simple Network Management Protocol, SNMP;
a network configuration protocol, NETCONF;
a Customer Premise Equipment, CPE, wireless area network management protocol, TR069;
a web open source system, WEBGUI, -based management manner;
a File Transfer Protocol, FTP;
a Trivial File Transfer Protocol, TFTP;
a Secure File Transfer Protocol, SFTP;
a system log;
a Yet Another Next Generation, YANG language mode; and
a Border Gateway Protocol, BGP.

15. The system as claimed in claim 10, the system further comprises: a first forwarding device in the multiple forwarding devices, wherein
the first forwarding device comprises:
a receiving component, configured to receive a data message to be forwarded to one or more second forwarding devices in the multiple forwarding devices;
an encapsulation component, configured to acquire encapsulation mode information and key information from the parameter set, and perform, according to the encapsulation mode information and the key information, encryption and encapsulation processing on the data message to be forwarded; and
a sending component, configured to send the encapsulated data message to the one or more second forwarding devices.

16. The system as claimed in claim 15, the system further comprises: the one or more second forwarding devices, wherein
each of the one or more second forwarding devices comprises:
a decryption component, configured to acquire decryption information from the parameter set, and decrypt the data message to be forwarded according to the decryption information; and
a forwarding component, configured to forward the decrypted data message.

17. The system as claimed in claim 10, wherein the central controller further comprises:
a determination component, configured to determine that a life cycle of the SA ends; and
a creation component, configured to recalculate key information and recreate a parameter set to re-establish an SA.

18. The system as claimed in claim 10, wherein the parameter sets comprise at least one of:
a Virtual Private Network, VPN, type between the each pair of the forwarding devices in the multiple forwarding devices;
a Security Parameter Index, SPI, configured for the each of the multiple forwarding devices by the central controller;
an IPSec tunnel source Internet Protocol, IP, address configured for the each of the multiple forwarding devices by the central controller;
an IPSec tunnel destination IP address configured for the each of the multiple forwarding devices by the central controller;
a security protocol configured for the each of the multiple forwarding devices by the central controller;
an encapsulation mode configured for the each of the multiple forwarding devices by the central controller;
an encryption algorithm configured for the each of the multiple forwarding devices by the central controller;
an encryption key calculated for the each of the multiple forwarding devices by the central controller;
an integrity algorithm configured for the each of the multiple forwarding devices by the central controller;
an integrity key calculated for the each of the multiple forwarding devices by the central controller;
an anti-replay window size configured for the each of the multiple forwarding devices by the central controller;
an SA life cycle type configured for the each of the multiple forwarding devices by the central controller;
an Encapsulating Security Payload, ESP, algorithm mode configured for the each of the multiple forwarding devices by the central controller; and
an encryption mode configured for the each of the multiple forwarding devices by the central controller.

19. A device for sending configuration information, comprising:
a configuration component, configured to respectively configure a parameter set for each of multiple forwarding devices, wherein the parameter set is used for establishing an Security Associations, SA, between each pair of forwarding devices in the multiple forwarding devices;
a creation component, configured to negotiate with the each of the multiple forwarding devices and create one or more security channels between the central controller and the each of the multiple forwarding devices; and
a sending component, configured to send the parameter set to the each of the multiple forwarding devices through the one or more security channels.
